(19) United States
(12) Patent Application Publication
(10) Pub. No.: US 2024/0413733 A1
(43) Pub. Date: Dec. 12, 2024

(54) Power Conversion Circuit and Electronic Device

(71) Applicant: Honor Device Co., Ltd., Shenzhen (CN)

(72) Inventor: Mingjian Wu, Shenzhen (CN)

(21) Appl. No.: 18/043,830

(22) PCT Filed: Aug. 25, 2022
(86) PCT No.: PCT/CN2022/114773

§ 371 Date: Jun. 14, 2024

(30) Foreign Application Priority Data
Nov. 26, 2021 (CN) 202111421896.7

(51) Int. Cl. H02M 1/00; H02M 3/06; H02M 3/156

(52) U.S. Cl. CPC H02M 1/0032; H02M 1/0025; H02M 3/06; H02M 3/156

(57) ABSTRACT

This application provides a power conversion circuit and an electronic device. In the power conversion circuit, a configuration resistor of the power conversion circuit is disposed between a set input end of a power converter and a ground, a resistance value is controllable, and the configuration resistor is configured to generate a configuration voltage for the set input end at a corresponding resistance value. The power converter of the power conversion circuit can generate and output a corresponding output voltage based on the configuration voltage. That is, in this application, regulation of the output voltage is implemented by adjusting a resistance value of the configuration resistor. In addition, a voltage divider resistor responsible for collecting the output voltage is disposed in the power converter, to control a parasitic parameter. Therefore, a resistance value of the voltage divider resistor may be set to be greater than a preset value, to reduce a leakage current, so that a quiescent current of the power converter is reduced.

This application claims priority to Chinese Patent Application No. 202111421896.7, filed with the China National Intellectual Property Administration on Nov. 26, 2021 and entitled “POWER CONVERSION CIRCUIT AND ELECTRONIC DEVICE”, which is incorporated herein by reference in its entirety.

### TECHNICAL FIELD

This application relates to the field of power electronics technologies, and in particular, to a power conversion circuit and an electronic device.

### BACKGROUND

With widespread popularization of wearable devices, maximizing standby time of the wearable devices has become a key research direction. A quiescent current of a power converter chip is an important factor that affects standby duration, especially standby duration in a sleeping period. However, because the power converter chip needs to regulate an output voltage of the power converter chip, so that the output voltage stabilizes at a set configuration value, to further adapt to requirements of different load, even in the sleeping period. However, a quiescent current caused by this process is usually relatively high. Therefore, currently, a voltage regulation solution with a relatively low quiescent current needs to be provided urgently.

### SUMMARY

In view of this, this application provides a power conversion circuit and an electronic device, to reduce a quiescent current caused by a voltage regulation process.

To achieve the foregoing objective, the following technical solutions are provided in this application:

A first aspect of this application provides a power conversion circuit. A configuration resistor of the power conversion circuit is disposed between a set input end of a power converter and a ground, a resistance value is controllable, and the configuration resistor is configured to generate a configuration voltage for the set input end at a corresponding resistance value. The power converter of the power conversion circuit can generate and output a corresponding output voltage based on the configuration voltage. That is, in this application, regulation of the output voltage is implemented by adjusting a resistance value of the configuration resistor. In addition, a voltage divider resistor responsible for collecting the output voltage is disposed in the power converter, to control a parasitic parameter. Therefore, a resistance value of the voltage divider resistor may be set to be greater than a preset value, to reduce a leakage current, so that a quiescent current of the power converter is reduced.

In a possible implementation, the configuration resistor includes at least two resistors and at least one switch. The at least one switch is configured to put all or some of the at least two resistors between two ends of the configuration resistor based on received on-off control. That is, a resistance value of the configuration resistor can be adjusted by changing a quantity of resistors connected. An optional solution is that each resistor is separately connected in series with a corresponding switch to form a series branch circuit, series branch circuits are connected in parallel, and two ends formed after a parallel connection are used as two ends of the configuration resistor.

In a possible implementation, the power converter includes a voltage source, a capacitor, and an error amplifier. The voltage source is powered by a power supply end of the power converter. The voltage source is connected to a first end of the capacitor by using a resistor. The first end of the capacitor is further connected to the set input end and any input end of the error amplifier. A second end of the capacitor is grounded. According to this structure setting, a corresponding configuration voltage may be generated after the configuration resistor is charged by using the voltage source, and the configuration voltage is stably transmitted, by using the capacitor, to the error amplifier for subsequent calculation and control. In addition, a current source may be used to replace the voltage source and the resistor. In a possible implementation, the first end of the capacitor is connected to a reference input end of the error amplifier, and therefore, adjustment of a resistance value of the configuration resistor affects control of the output voltage by using a received signal of the reference input end of the error amplifier. In a possible implementation, the first end of the capacitor is connected to a feedback input end of the error amplifier, and therefore, adjustment of a resistance value of the configuration resistor affects control of the output voltage by using a received signal of the feedback input end of the error amplifier.

In a possible implementation, in the power converter, an analog-to-digital converter, a register, and a digital-to-analog converter are further disposed between the first end of the capacitor and a corresponding input end of the error amplifier. The analog-to-digital converter is powered by the power supply end, and is configured to convert the configuration voltage into a digital signal. The register is configured to store the digital signal. The digital-to-analog converter is configured to convert the digital signal into an analog signal and output the analog signal to the corresponding input end of the error amplifier. In this case, a storage function for the configuration voltage can be implemented by using the register. In addition, a resistor network may be used to replace the digital-to-analog converter.

In a possible implementation, in the power converter, the power supply end supplies power to the voltage source or the current source, and supplies power to the analog/digital converter by using a switching transistor. In addition, the power converter further includes an off-control unit, configured to control periodical turning on and turning off of the switching transistor. Further, the storage function of the register can enable the power converter to implement a regulation function for the output voltage without powering off by using the off-control unit. Optionally, the off-control unit may be an RC timer: or when the power converter includes a clock, the off-control unit may also be a counter.

A second aspect of this application further provides an electronic device, including a processor, a battery, a charging management module, and the power conversion circuit according to any one of the foregoing paragraphs of the first aspect. The charging management module and the power conversion circuit are separately controlled by the processor. The charging management module is configured to charge the battery. The power conversion circuit receives power supplied by the battery or the charging management module. The power conversion circuit can implement regulation of the output voltage of the power conversion circuit by adjusting a resistance value of a configuration resistor of the power conversion circuit, so that a power supply voltage required by corresponding load in the electronic device can be provided for corresponding load in the electronic device.

It should be understood that descriptions of technical features, technical solutions, beneficial effects, or the like in this application are not intended to imply that all features and advantages may be implemented in any single embodiment. On the contrary, it can be understood that descriptions of the features or beneficial effects means that specific technical features, technical solutions or beneficial effects are included in at least one embodiment. Therefore, descriptions of the technical features, technical solutions, or beneficial effects in this specification do not necessarily refer to a same embodiment. Further, the technical features, technical solutions, and beneficial effects described in the embodiments may be combined in any appropriate manner. A person skilled in the art will understand that an embodiment may be implemented without one or more specific technical features, technical solutions or beneficial effects of a specific embodiment. In other embodiments, additional technical features and beneficial effects may also be identified in specific embodiments that do not reflect all embodiments.

### BRIEF DESCRIPTION OF DRAWINGS

To describe technical solutions in embodiments of this application or in the conventional technology more clearly, the following briefly describes the accompanying drawings needed for describing embodiments or the conventional technology. Apparently, the accompanying drawings in the following descriptions merely show embodiments of this application, and a person of ordinary skill in the art can still derive other drawings from provided accompanying drawings without creative efforts.

FIG. 1a, FIG. 1b, and FIG. 1c are schematic diagrams of three voltage regulation solutions of a power converter:

FIG. 2 is a schematic diagram of a structure of a power conversion circuit according to an embodiment of this application:

FIG. 3a, FIG. 3b, FIG. 3c, and FIG. 3d are schematic diagrams of four structures of resistor configuration according to an embodiment of this application:

FIG. 4a and FIG. 4b are signal waveform graphs of two voltage regulation processes of a power conversion circuits according to an embodiment of this application:

FIG. 5a, FIG. 5b, FIG. 5c, FIG. 6a, FIG. 6b, and FIG. 6c are schematic diagrams of other six structures of a power conversion circuit according to an embodiment of this application; and

FIG. 7 is a schematic diagram of a module structure of an electronic device according to an embodiment of this application.

### DESCRIPTION OF EMBODIMENTS

In the specification, claims, and accompanying drawings of this application, the terms “first”, “second”, “third”, and the like are intended to distinguish between different objects but not to limit a particular order.

In an embodiment of this application, the word such as “as an example” or “for example” is used to represent giving an example, an illustration, or a description. In embodiments of this application, any embodiment or design solution described as “for example” or “such as” shall not be explained as being more preferred or advantageous than other embodiments or design solutions. Specifically, use of the words “for example” and “such as” is intended to present a relevant concept in a specific way.

A power converter chip may be applied to different electronic devices, for example, a wearable device such as a smartwatch, a smart band, or a Bluetooth headset. Even if the power converter chip is applied to a same electronic device, the power converter chip may face different power supply requirements. To adapt to power supply requirements of different load, the chip needs to be capable of outputting a plurality of output voltages of different values, such as 0.7 V and 1.8 V. Therefore, an output voltage of the chip needs to be set and regulated, so that the output voltage can stably provide a voltage value required by corresponding load.

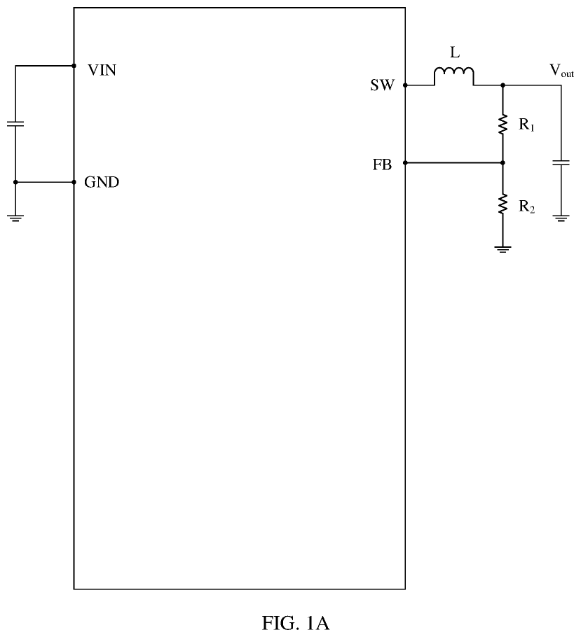

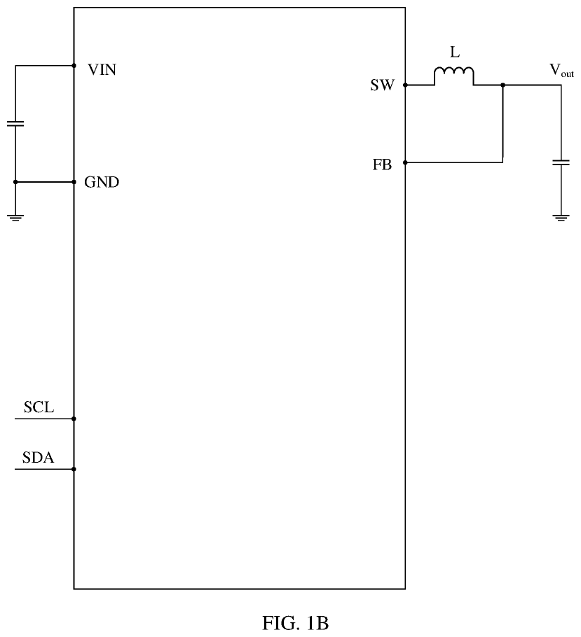

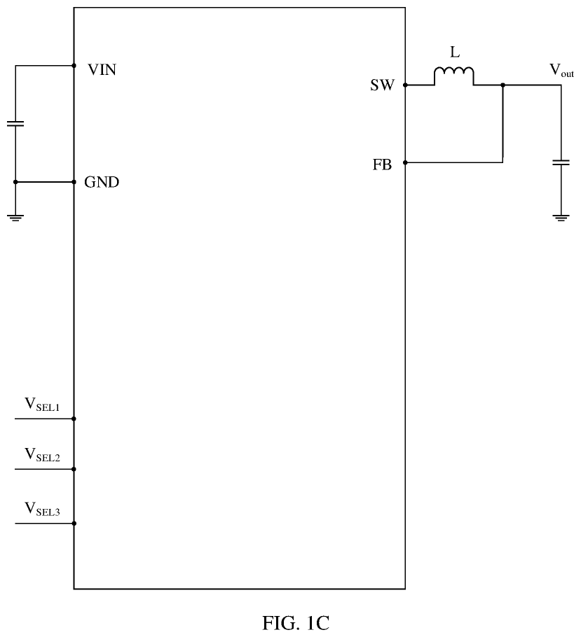

Currently, for output voltage regulation of the chip, if a voltage divider resistor voltage regulation solution shown in FIG. 1a is used, that is, voltage divider resistors R₁ and R₂ outside a chip (as shown in a block in the figure) are used to collect an output voltage Vₒᵤₜ for subsequent calculation and regulation by a processor of an electronic device, in actual application, selected resistance values of the voltage divider resistors R₁ and R₂ cannot be too large. A specific reason is that a connection between the voltage divider resistors R₁ and R₂ and the chip needs to be implemented by using corresponding wires, these wires inevitably lead to a parasitic capacitor and a parasitic inductor, and these parasitic components introduce interference in a coupling manner. As interference sources, internal resistances of these parasitic components are generally high. Therefore, a larger resistance value of the voltage divider resistor indicates a greater interference divided to the voltage divider resistor. In addition, because an external wire of the chip is usually random, parameters of these parasitic components are not controllable, and consequently, interference caused by these parasitic parameters is not controllable. Therefore, to reduce impact of these parasitic components on a voltage division result, the selected resistance values of the voltage divider resistors R₁ and R₂ cannot be too large, provided that impact that is of a voltage difference brought by interference and that is on a voltage division result can be ignored. A wearable device usually used output voltage Vₒᵤₜ=1.8 V is used as an example. The voltage divider resistors R₁+R₂ are valued as 150 kΩ, and a current flowing on the voltage divider resistors is I_{(R1+R2)}=1.8 V/150 k≤2=12 uA. For a wearable device, 12 uA indicates that a quiescent current is excessively high. A VIN pin is a power supply end of the chip, a GND pin is configured to implement a grounding connection, a voltage output by an SW pin can generate the output voltage Vₒᵤₜ by using an external inductor L, and an FB pin is configured to collect the output voltage Vₒᵤₜ and feed back the voltage into the chip.

If an I²C communication function is used to implement voltage regulation, that is, as shown in FIG. 1b, the chip receives a control signal by using an SCL pin, and receives a data signal by using an SDA pin, to implement setting and regulation of the output voltage Vₒᵤₜ. Therefore, a corresponding electronic device can have the I²C communication function only after a processor of the corresponding electronic device is powered up. The SDA pin then is capable of receiving a corresponding data signal. Therefore, this solution is not applicable to a scenario in which communication is performed after powering up. For example, in a scenario in which the chip is used to supply power to a camera in an electronic device, for the chip whose initial default value of the output voltage Vₒᵤₜ is 1.8 V, when the chip faces a rated power supply voltage requirement of 1.2 V of the camera, the processor needs to transmit the data signal for the SDA pin of the chip by using the I²C communication function, so that the output voltage Vₒᵤₜ can be regulated to 1.2 V. However, because the initial default value of the output voltage Vₒᵤₜ of the chip after powering up is 1.8 V, in a time period from powering up of the processor to starting of communication, a power supply voltage received by the camera is 1.8 V, which is higher than a rated power supply voltage of the camera, and a camera burnout may be caused. Therefore, this solution is not applicable to the scenario in which communication is performed after powering up. In addition, in this solution, the I²C communication needs to be online in real time, to wait for the processor to generate the data signal and then transmit the data signal, so as to ensure that the SDA pin can receive the data signal. Therefore, a quiescent current of the solution is also usually higher than 2 uA.

If a VSEL true value table is used to implement voltage regulation, that is, as shown in FIG. 1c, the chip uses three set pins V_{SEL1}, V_{SEL2}, and V_{SEL3} to configure the output voltage Vₒᵤₜ, these three set pins can only provide a total of 2³=8 voltage values. Therefore, regulation levels of the output voltage Vₒᵤₜ of the chip are relatively small in quantity and inflexible. In addition, a larger quantity of set pins indicates a larger chip size.

Therefore, this application provides a power conversion circuit. The power conversion circuit can significantly reduce a quiescent current, and can further implement output voltages of more values and reduce a chip size, and therefore is applicable to a wearable device.

The power conversion circuit is disposed in an electronic device, and is controlled by a processor in the electronic device. The electronic device may be a wearable device such as a smartwatch, a smart band, or a Bluetooth headset, or may be a mobile terminal device such as a mobile phone or a tablet computer. For details, refer to the description in the last embodiment. The following uses a wearable device as an example for description.

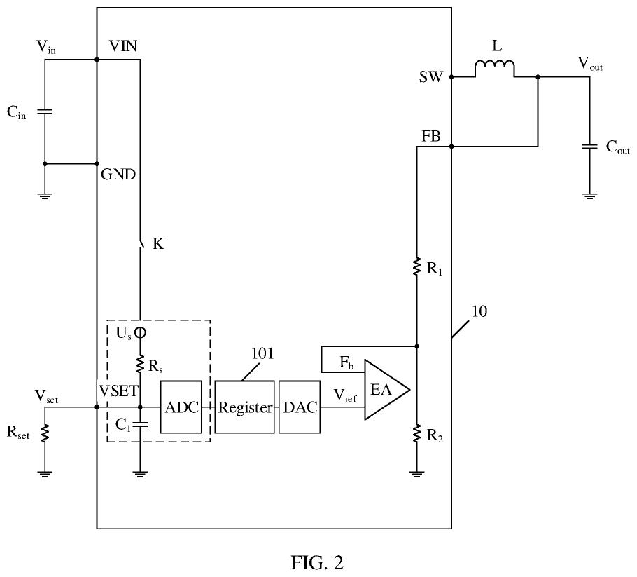

As shown in FIG. 2, the power conversion circuit includes a power converter 10 and a configuration resistor Rₛₑₜ.

The power converter 10 is disposed in a power management module of the wearable device, and may specifically be a chip for implementing DC/DC conversion, such as a buck chip, a boost chip, or a buck-boost chip. The power converter 10 receives, by using an external input capacitor Cᵢₙ between a VIN pin and a GND pin, an input voltage Vᵢₙ provided by a battery or a charging management module in the wearable device, performs corresponding conversion on the input voltage Vᵢₙ, performs filtering on an inductor L connected to the outside of an SW pin, and generates an output voltage Vₒᵤₜ on an output capacitor Cout between the other side of the inductor L and the ground. The output voltage Vₒᵤₜ is used to supply power to another component in the wearable device, such as a processor, a speaker, a memory, a motor, a flexible screen, a camera, and a wireless communication module. Internal components in different electronic devices may require different voltages, such as 0.7 V, 1.2 V, or 1.8 V. To enable a power conversion circuit of a same model to cover a plurality of different output voltages and adapt to different application scenarios, a corresponding voltage regulation function needs to be configured for the power conversion circuit.

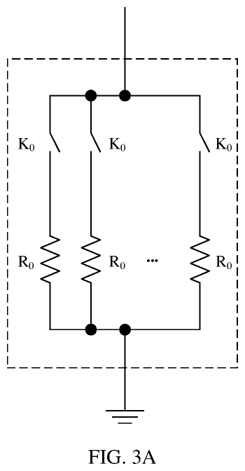

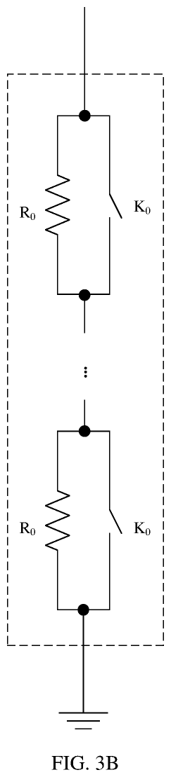

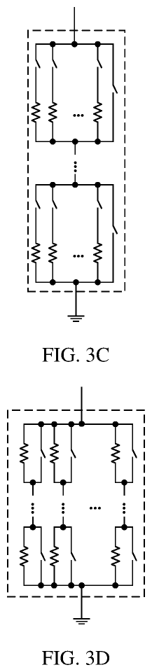

The configuration resistor Rₛₑₜ is disposed between a set input end VSET of the power converter 10 and a ground, and is configured to set a resistance value based on control of the processor. In a specific example, the configuration resistor Rₛₑₜ is implemented by using at least two resistors connected in parallel. Referring to FIG. 3a, each resistor R₀ is separately connected in series with a corresponding switch K₀ to form a series branch circuit. Then these series branch circuits are connected in parallel, and two ends formed after a parallel connection are used as two ends of the configuration resistor Rₛₑₜ. The processor changes a specific quantity of resistors R₀ connected inside the configuration resistor Rₛₑₜ by controlling turning on and turning off of each switch K₀, to further change an equivalent resistance value of the configuration resistor Rₛₑₜ. In actual application, resistance values of the resistors R₀ may be identical, or may be partially different, or even may be different from each other, which all fall within the protection scope of this application. Alternatively, the configuration resistor Rₛₑₜ may be implemented by using at least two resistors R₀ connected in series. In this case, each resistor R₀ is further connected in parallel to a corresponding switch K₀. A structure is shown in FIG. 3b. In this case, the switch K₀ in a closed state can bypass a resistance R₀ connected in parallel, to reduce a quantity of resistors put into a series connection relationship in the configuration resistor Rₛₑₜ. Or the switch K₀ in a disconnected state can put a resistor R₀ connected in parallel into the series connection relationship. This structure can also implement a change of an equivalent resistance value of the configuration resistor Rₛₑₜ, and resistance values of the resistors R₀ in this structure are not specifically limited. However, as in a structure shown in FIG. 3b, reference ground electrical level conversion of a control end needs to be performed on each switch K₀ other than a switch K₀ at a lowest end, to ensure that an on-off control electrical level of each switch K₀ is unified. Therefore, an implementation of this structure is more complex than the structure shown in FIG. 3a. In actual application, a combination of the structures shown in FIG. 3a and FIG. 3b may be further used to set a resistance value of the configuration resistor Rₛₑₜ, such as a structure shown in FIG. 3c with a series connection after a parallel connection, a structure shown in FIG. 3d with a parallel connection after a series connection, or a more complex structure with a series connection and a parallel connection. Any solution in which the processor puts all or some of the at least two resistors between two ends of the configuration resistor Rₛₑₜ by controlling turning on and turning off of at least one switch falls within the protection scope of this application.

In a specific example, as shown in FIG. 2, a switching transistor K, a voltage source Uₛ, a resistor Rₛ, a capacitor C₁, an ADC (Analog-to-Digital Converter, analog-to-digital converter), a register 101, a DAC (Digital-to-Analog Converter, digital-to-analog converter), and an EA (error amplifier, error amplifier) are disposed inside the power converter 10. The voltage source Uₛ is connected to a first end of the capacitor C₁, a set input end VSET, and an input end of the ADC after passing through the resistor Rₛ. An output end of the ADC is connected to a reference input end of the EA after sequentially passing through the register 101 and the DAC.

A VIN pin of the power converter 10 serves as a power supply end of the power converter 10, and may supply power to a component inside the power converter 10 by using the switching transistor K. For example, the VIN pin may supply power to the voltage source Uₛ and the ADC in a dashed-line box in FIG. 2. The switching transistor K may specifically be a MOS transistor, but is not limited thereto. After the power converter 10 is powered up, that is, after the VIN pin is powered up, the processor controls the switching transistor K to be closed, and the voltage source Uₛ and the ADC are powered up. The voltage source Uₛ can output a stable voltage. The resistor Rₛ and a configuration resistor Rₛₑₜ whose resistance value is set and that is outside the chip perform voltage division on the stable voltage. A voltage value Vₛₑₜ is obtained on the configuration resistor Rₛₑₜ. The voltage value Vₛₑₜ is a configuration voltage generated at a corresponding resistance value of the configuration resistor Rₛₑₜ for the set input end VSET (that is, a VSET pin). The configuration voltage Vₛₑₜ can be maintained in a stable state by using the capacitor C₁ inside the chip, then read and converted into a digital signal by the ADC, and locked in the register 101. The digital signal in the register 101 is then converted into an analog signal V_{ref} by using the DAC, V_{ref}=Vₛₑₜ. The analog signal V_{ref} is input to the reference input end of the EA and is used as a reference voltage of a control loop, to implement reference setting of the output voltage Vₒᵤₜ, so that the processor can control the power converter 10, and generate and output a corresponding output voltage Vₒᵤₜ based on the configuration voltage Vₛₑₜ.

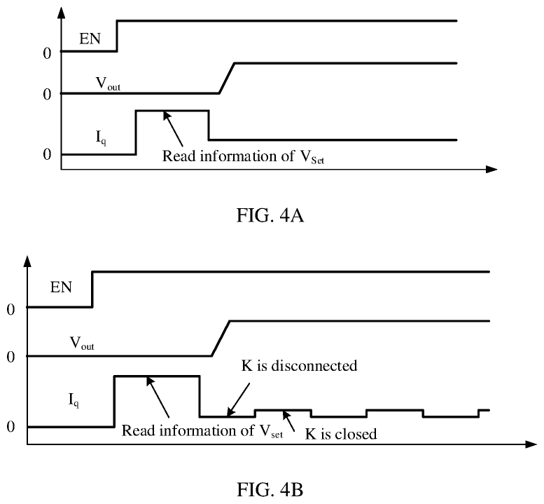

In addition, the output voltage Vₒᵤₜ is collected through voltage division collection by using grounded voltage divider resistors R₁ and R₂. A voltage value Fb on the grounded resistor R₂ is a collection value of the output voltage Vₒᵤₜ, and is input to a feedback input end of the EA as a feedback voltage Fb of the control loop, so that the processor reduces a difference between the feedback voltage Fb and the analog signal V_{ref}, to implement regulation of the output voltage Vₒᵤₜ. In addition, the voltage divider resistors R₁ and R₂ are disposed inside the power converter 10. One of reasons is that the voltage divider resistors are close to the EA, and the other reason is that connection wires of the voltage divider resistors may be disposed based on the voltage divider resistors, to control a parasitic parameter. Therefore, a resistance value of the voltage divider resistor may be set to be very large, and the resistance value may be set to be greater than a specific preset value in actual application, so that a leakage current is very low, and a quiescent current of the chip is further reduced. For a signal waveform graph of the chip, refer to FIG. 4a. A high EN indicates that the VIN pin is powered up, and I_{q} represents a current flowing into the VIN pin. The current is a quiescent current in a standby state of the power converter 10, and a segment of the current with a highest value represents a time period in which the ADC reads information of the configuration voltage Vₛₑₜ.

It can be learned from a waveform of I_{q} in FIG. 4a that, in this application, a quiescent current of the ADC is relatively high only when the ADC is powered up to read the information of the configuration voltage Vₛₑₜ, and an ultra-low quiescent current operation can be maintained in a subsequent steady-state phase. In addition, in this application, a voltage setting function can be implemented by using only one VSET pin, and the power converter 10 can be implemented by using a chip with a relatively small size. In addition, more equivalent resistance values that can be implemented by the configuration resistor Rₛₑₜ in this application indicate more regulation levels for the output voltage Vₒᵤₜ and more flexible regulation that can be implemented, so that a disadvantage of a voltage regulation range limitation of a conventional low power consumption power converter chips is overcome. Further, continuous voltage regulation can be implemented with high ADC accuracy. Further, in this application, regulation of the output voltage Vₒᵤₜ does not need to be performed by using the I²C communication, so that no I²C communication port is required, and the I²C communication does not need to be online in real time. When a resistance value of the configuration resistor Rₛₑₜ is set, a corresponding output voltage Vₒᵤₜ can be output after powering up. This can be applicable to a scenario in which communication is performed after powering up.

In another example, a low-precision resistor network may be used to replace the DAC in FIG. 2, and a principle for a structure setting of the resistor network is the same as that of the configuration resistor Rₛₑₜ. Refer to FIG. 3a to FIG. 3d. Details are not described herein. A voltage regulation step in this manner is affected by the structure setting of the resistor network. Therefore, a resistance value and a connection relationship of each component resistor inside the resistor network may be adjusted adaptively in actual application, which falls within the protection scope of this application.

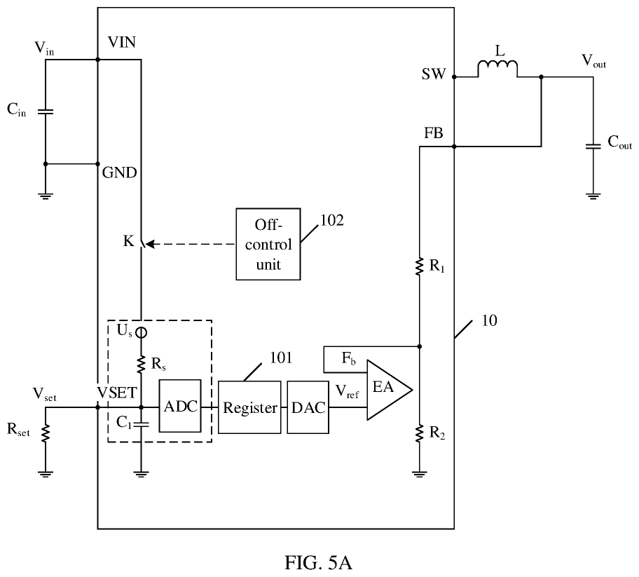

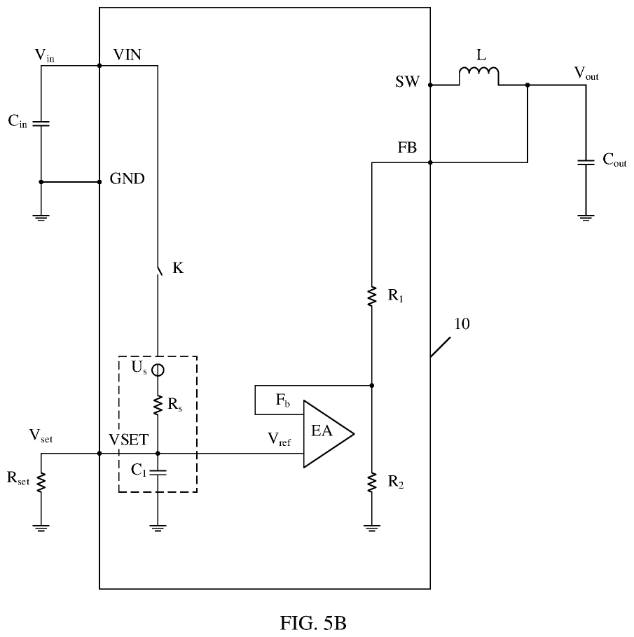

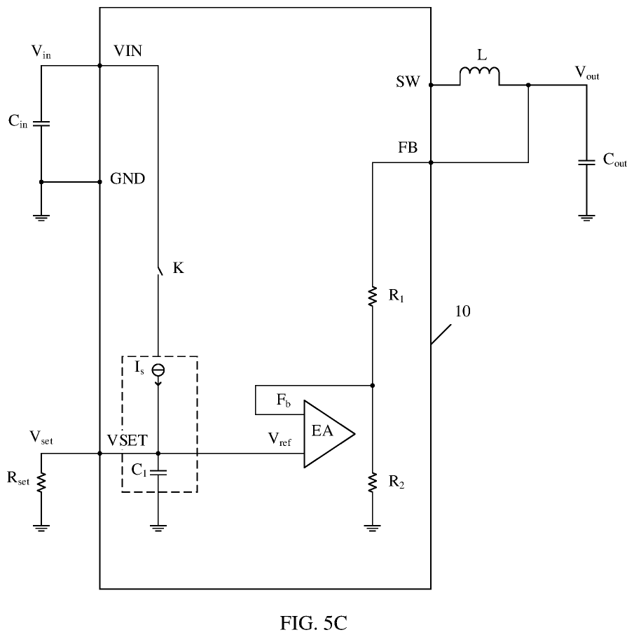

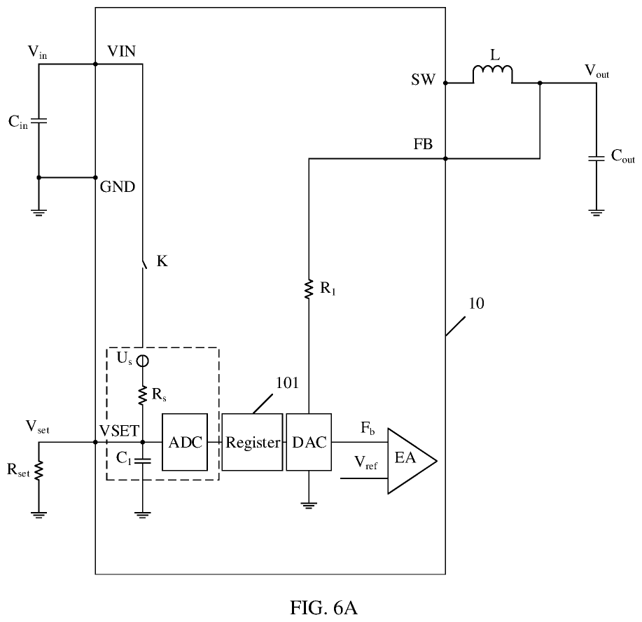

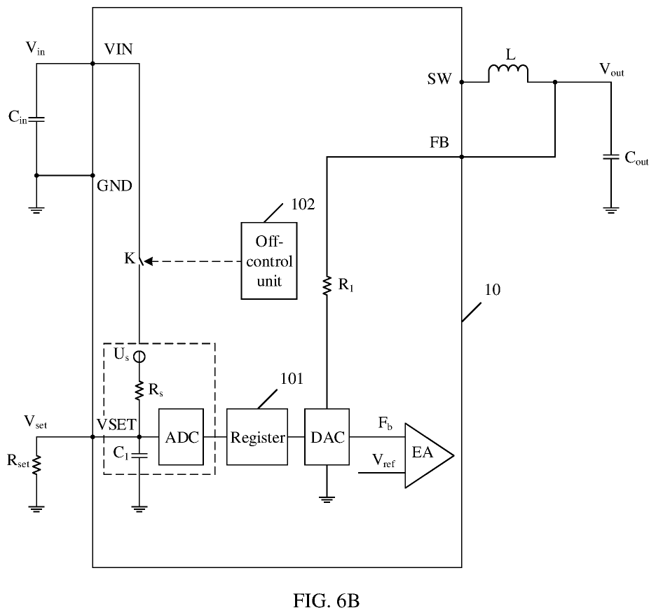

Based on that the voltage divider resistors R₁ and R₂ with high resistances can reduce a quiescent current, additionally, because the configuration voltage Vₛₑₜ is converted into the digital signal by the ADC and is stored in the register 101, and the digital signal stored in the register 101 is converted into the analog signal V_{ref} by the ADC, that is, only analog-to-digital conversion, storing, and digital-to-analog conversion are performed in a process from Vₛₑₜ to V_{ref}, there is V_{ref}=V set. Therefore, after the DAC converts the digital signal in the register 101 into the analog signal V_{ref}, even if the switching transistor K is controlled to be disconnected and the voltage source Uₛ and the ADC are powered off, the register 101 may continue to provide the analog signal V_{ref} by using the DAC. This ensures that the reference input end of the EA can continuously receive the reference voltage of the control loop, and the power converter 10 can still generate and output the corresponding output voltage Vₒᵤₜ based on the configuration voltage Vₛₑₜ. In this case, because the voltage source Uₛ and the ADC are powered off, power consumption of the voltage source Uₛ and the ADC can be further saved, so that the quiescent current I_{q} can be further reduced on the basis of FIG. 4a, and as shown in FIG. 4b, the current is further significantly reduced. A specific example is as follows: An off-control unit 102 shown in FIG. 5a indirectly controls periodical turning on and turning off of the switching transistor K by using the processor. The off-control unit 102 may specifically be an RC timer, and may periodically turn on and turn off the switching transistor K by setting a specific duration, such as 10 ms. In this way, a resistance value of the configuration resistor Rₛₑₜ can be adjusted at any time, and the VIN pin does not need to be powered off during a running process of the chip. The digital signal stored in the register 101 is changed when the voltage source Uₛ and the ADC are powered up next time by using a storage function of the register 101, so that a register value updating function without powering off of the chip is implemented, then the analog signal V_{ref} output by the DAC is changed, regulation of the output voltage Vₒᵤₜ after powering up is implemented. In this case, a magnitude of the quiescent current I_{q} changes periodically when the switching transistor K is turned on and turned off. As shown in FIG. 4b, when the switching transistor K is closed, the voltage source Uₛ and the ADC have corresponding power consumption, and therefore a value of the quiescent current I_{q} in FIG. 4b is the same as that in the steady-state phase in FIG. 4a. When the switching transistor K is disconnected, the quiescent current I_{q} can be further reduced.

In actual application, if a clock is disposed in the power converter 10, the off-control unit 102 may also be a counter that cooperates with a clock reference signal, and the foregoing function can also be implemented. Details are not described again.

In addition, when there is no off-control unit 102 in the power converter 10, there may be no ADC, the register 101, and the DAC. In this case, as shown in FIG. 5b, the VSET pin is inside the power converter 10, and is directly connected to the first end of the capacitor C₁ and the reference input end of the EA. This structure can also produce an effect shown in FIG. 4a, that is, an ultra-low quiescent current operation can be maintained in the steady-state phase. However, because a periodic turning off function brought by the off-control unit 102 and the storage function brought by the register 101 are omitted, this structure no longer has the register value updating function without powering off brought by a structure shown in FIG. 5a. In this case, the switching transistor K may be reserved. After the VIN pin is powered up, the switching transistor K is controlled by the processor and kept closed, and after the power converter 10 is normally powered off, appropriate delayed turning off may be selected, to implement voltage leakage on the input capacitor Cᵢₙ, or a direct turning off may be selected. Certainly, for cases shown in FIG. 2, FIG. 5a, and FIG. 5b, the switching transistor K may also be selectively omitted. In this case, power supply for a component in a dashed-line box in each figure is performed when the VIN pin is powered up.

In addition, in the power converter 10, a current source Is may be used to replace the voltage source Uₛ and a resistor Rₛ. A structure is shown in FIG. 5c. In this case, a value of the configuration voltage Vₛₑₜ and a resistance value of the configuration resistor Rₛₑₜ change in a constant positive proportional relationship. In addition, FIG. 5c shows a transformation of the structure shown in FIG. 5b. In actual application, the voltage source Uₛ and the resistor Rₛ in FIG. 2 and FIG. 5a may also be replaced by the current source Is. Illustrations are not provided one by one.

For the foregoing various structures in the power converter 10, a change of a received signal may be further performed on two inputs of the EA to obtain a corresponding transformation structure. Specifically, the reference input end of the EA is changed to receive a fixed reference voltage V_{ref}, and a received signal of a feedback voltage Fb of the feedback input end of the EA is adjusted in the foregoing corresponding form. After the foregoing change of the EA input end is performed on a structure shown in FIG. 2, an obtained transformation structure diagram is shown in FIG. 6a: after the foregoing change of the EA input end is performed on the structure shown in FIG. 5a, an obtained transformation structure diagram is shown in FIG. 6b: after the foregoing change of the EA input end is performed on the structure shown in FIG. 5b, an obtained transformation structure diagram is shown in FIG. 6c; and a state of a current source corresponding to FIG. 5c is not shown by a diagram. All the transformation structures fall within the protection scope of this application. In this solution, regulation of the output voltage Vₒᵤₜ is still implemented by adjusting a resistance value of the configuration resistor Rₛₑₜ. A specific regulation principle is similar to the foregoing content, and details are not described again.

Another embodiment of this application further provides an electronic device. The electronic device may be a mobile terminal device such as a mobile phone, a portable android device (portable android device, PAD), a desktop computer, a laptop computer, a notebook computer, an ultra-mobile personal computer (Ultra-mobile Personal Computer, UMPC), a handheld computer, a netbook, a personal digital assistant (Personal Digital Assistant, PDA), and a wearable device. The wearable device includes, but is not limited to, a smartwatch, a smart band, a Bluetooth headset, and the like. A form of the electronic device is not specifically limited in this embodiment of this application.

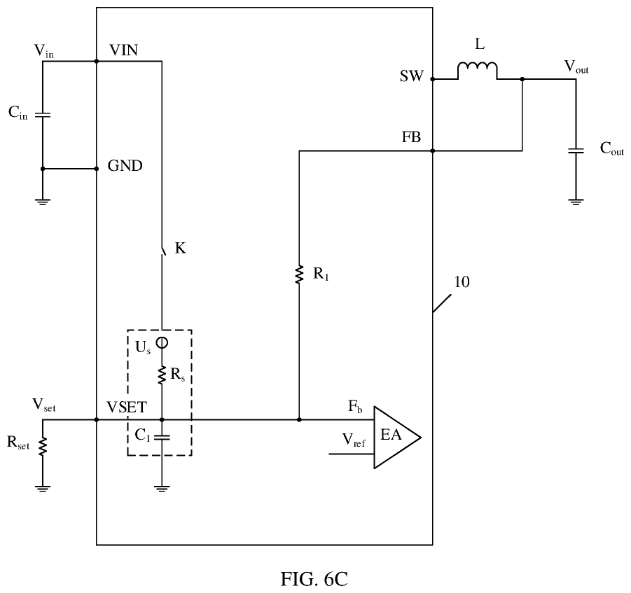

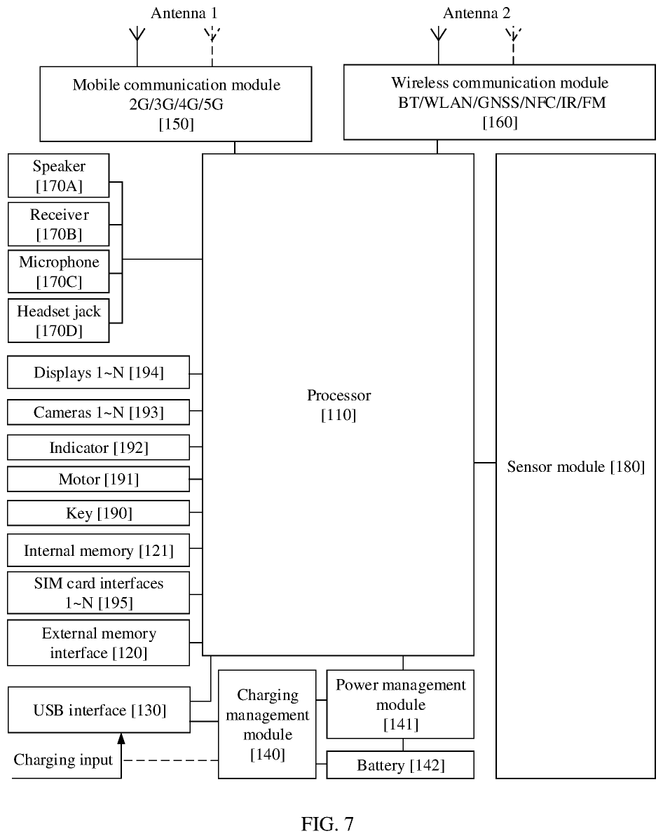

Referring to FIG. 7, the electronic device may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a key 190, a motor 191, a micro motor 191A, an indicator 192, a camera 193, a display 194 (a flexible display), and a SIM card interface 195. The sensor module 180 may include a pressure sensor, a gyro sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

It can be understood that the structure illustrated in this embodiment of this application does not constitute a specific limitation to the electronic device. In some other embodiments of this application, the electronic device may further include more or fewer components than those shown in the figure, or may combine some components, or may split some components, or may have different component arrangements. The illustrated components may be implemented by using hardware, software, or a combination of software and hardware. For example, components such as the headset jack 170D, the sensor module 180, the micro motor 191A, the camera 193, the display 194 (the flexible display), and the SIM card interface 195 do not need to be disposed in a Bluetooth headset, and the components may be determined based on a specific application environment of the device, which all fall within the protection scope of this application.

The USB interface 130 is an interface compliant with USB standards and specifications, and may specifically be a mini USB interface, a micro USB interface, a USB type C interface, or the like. The USB interface 130 may be configured to connect a charger to charge the electronic device, may be configured to transmit data between the electronic device and a peripheral device, and may be further configured to connect a headset to play audio by using the headset. In addition, the interface may be further configured to connect to another electronic device, such as an AR device.

The charging management module 140 is configured to receive a charging input from an external charger. While charging the battery 142, the charging management module 140 may further supply power to the electronic device by using the power management module 141. The power management module 141 may include one or more power conversion circuits provided in the foregoing embodiments, and is configured to connect the battery 142, the charging management module 140, and the processor 110. The power management module 141 receives an input of the battery 142 and/or an input of the charging management module 140, and supplies power to the processor 110, the internal memory 121, the speaker 170A, the external memory, the motor 191, the flexible display 194, the camera 193, the wireless communication module 160, and the like by using a corresponding power conversion circuit. The power management module 141 may be further configured to monitor parameters such as a battery capacity, a battery cycle count, and a battery health status (leakage or impedance). In some other embodiments, the power management module 141 may alternatively be disposed in the processor 110. In some other embodiments, the power management module 141 and the charging management module 140 may alternatively be disposed in a same component.

The processor 110 may be an SoC (System-on-a-Chip, system-on-a-chip) in a device such as a mobile phone or a smartwatch, or a central processing unit in a device such as a tablet computer or a notebook computer, or may be an MCU (Microcontroller Unit, microcontroller unit) or the like. The processor 110 may specifically include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, a neural-network processing unit (neural-network processing unit, NPU), and/or the like. Different processing units may be independent components, or may be integrated into one or more processors. The controller may be a nerve center and a command center of the electronic device. The controller can generate an operation control signal based on instruction operation codes and a timing signal, and complete the control of fetching and executing instructions.

The processor 110 may be further provided with a memory for storing instructions and data. In some embodiments, the memory in the processor 110 is a cache. The memory can store an instruction or data that the processor 110 has just used or used cyclically. If the processor 110 needs to reuse the instruction or the data, the instruction or the data may be directly invoked from the memory. Repeated access is avoided, and a waiting time of the processor 110 is reduced, thereby improving system efficiency.

In some embodiments, the processor 110 may include one or more interfaces. The interface may include an inter-integrated circuit (inter-integrated circuit, I²C) interface, an inter-integrated circuit sound (inter-integrated circuit sound, I²S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and the like.

Functions that can be implemented by another module in the electronic device are not described herein again.

The foregoing descriptions are merely specific implementations of this application, but are not intended to limit the protection scope of this application. Any variation or replacement made within the technical scope disclosed in this application shall fall within the protection scope of this application. Therefore, the protection scope of this application shall be subject to the protection scope of the claims.

1. A power conversion circuit, comprising: a power converter and a configuration resistor, wherein:
the configuration resistor is disposed between a set input end of the power converter and a ground, a resistance value is controllable, and the configuration resistor is configured to generate a configuration voltage for the set input end at a corresponding resistance value:
the power converter generates and outputs a corresponding output voltage based on the configuration voltage; and
a voltage divider resistor that collects the output voltage is disposed in the power converter, and a resistance value of the voltage divider resistor is greater than a preset value.

2. The power conversion circuit according to claim 1, wherein the configuration resistor comprises at least two resistors and at least one switch; and
the at least one switch is configured to put all or some of the at least two resistors between two ends of the configuration resistor based on received on-off control.

3. The power conversion circuit according to claim 2, wherein in the configuration resistor, each resistor is separately connected in series with a corresponding switch to form a series branch circuit, series branch circuits are connected in parallel, and two ends formed after a parallel connection are used as two ends of the configuration resistor.

4. The power conversion circuit according to any one of claims 1 to 3, wherein the power converter comprises a voltage source, a capacitor, and an error amplifier:
the voltage source is powered by a power supply end of the power converter:
the voltage source is connected to a first end of the capacitor by using a resistor:
the first end of the capacitor is further connected to the set input end and any input end of the error amplifier; and
a second end of the capacitor is grounded.

5. The power conversion circuit according to any one of claims 1 to 3, wherein the power converter comprises a current source, a capacitor, and an error amplifier:
the current source is powered by a power supply end of the power converter:
the current source is connected to a first end of the capacitor:
the first end of the capacitor is further connected to the set input end and any input end of the error amplifier; and
a second end of the capacitor is grounded.

6. The power conversion circuit according to claim 4 or 5, wherein the first end of the capacitor is connected to a reference input end of the error amplifier.

7. The power conversion circuit according to claim 4 or 5, wherein in the power converter, an analog-to-digital converter, a register, and a digital-to-analog converter are further disposed between the first end of the capacitor and a corresponding input end of the error amplifier:
the analog-to-digital converter is powered by the power supply end, and is configured to convert the configuration voltage into a digital signal:
the register is configured to store the digital signal; and
the digital-to-analog converter is configured to convert the digital signal into an analog signal and output the analog signal to the corresponding input end of the error amplifier.

8. The power conversion circuit according to claim 4 or 5, wherein in the power converter, an analog-to-digital converter, a register, and a resistor network are further disposed between the first end of the capacitor and a corresponding input end of the error amplifier:
the analog-to-digital converter is powered by the power supply end, and is configured to convert the configuration voltage into a digital signal:
the register is configured to store the digital signal; and
the resistor network is configured to convert the digital signal into an analog signal and output the analog signal to the corresponding input end of the error amplifier.

9. The power conversion circuit according to claim 7 or 8, wherein in the power converter, the power supply end supplies power to the voltage source or the current source, and supplies power to the analog/digital converter by using a switching transistor.

10. The power conversion circuit according to claim 9, wherein the power converter further comprises an off-control unit, configured to control periodical turning on and turning off of the switching transistor.

11. The power conversion circuit according to claim 10, wherein the off-control unit is an RC timer.

12. The power conversion circuit according to claim 10, wherein the power converter comprises a clock, and the off-control unit is a counter.

13. An electronic device, comprising: a processor, a battery, a charging management module, and the power conversion circuit according to any one of claims 1 to 12, wherein:
the charging management module and the power conversion circuit are separately controlled by the processor,
the charging management module is configured to charge the battery; and
the power conversion circuit receives power supplied by the battery or the charging management module.
